(19) United States
(12) Patent Application Publication
(10) Pub. No.: US 2014/0108201 A1
(43) Pub. Date: Apr. 17, 2014

(54) Method and System for the Location-Based Discovery and Validated Payment of a Service Provider

(71) Applicants: Stephen Patrick Frechette, Newton, MA (US); Jude Joujoute, Newton, MA (US)

(72) Inventors: Stephen Patrick Frechette, Newton, MA (US); Jude Joujoute, Newton, MA (US)

(21) Appl. No.: 14/105,222

(22) Filed: Dec. 13, 2013

Related U.S. Application Data
(62) Division of application No. 13/559,563, filed on Jul. 26, 2012.
(60) Provisional application No. 61/511,961, filed on Jul. 26, 2011.

(51) Int. Cl. G06Q 30/06

(52) U.S. Cl. CPC G06Q 30/0625; G06Q 30/0639
USPC 705/26.62

(57) ABSTRACT

A method and system for consumers to find service providers is presented. The method and system minimizes the amount of the consumer's time required to find a service provider to provide a desired service. The system employs real-time geolocation information available within mobile devices to increase the efficiency of the process. Either automated or manual two-way communication between consumers and service providers for discovery and payment allows for a quick and easy user experience for all parties involved.

### CROSS-REFERENCE TO RELATED APPLICATIONS

This application is a divisional of application Ser. No. 13/559,563, filed on Jul. 26, 2012, which claims the benefit of U.S. Provisional Patent Application No. 61/511,961, filed on Jul. 26, 2011, both of which are hereby incorporated herein by reference in their entirety.

### BACKGROUND OF THE INVENTION

1. Field of the Invention

The invention is a method and system for the location-based discovery of available Service Providers in the area, e.g., taxis. The problem that this invention solves is as follows:

The problem is how Consumers find available Service Providers in the area that are available to provide the service, e.g., a Consumer needs a taxi.

A Consumer often wastes a large amount of time trying to find a Service Provider to provide a specific service. Often this process includes email exchanges, phone interviews, appointments and estimates. The cost the Consumer incurs in terms of time wasted and missed work, for meeting with Service Providers for estimates and bids, often outweighs the entire financial cost of the task. Additionally, the wait time for a phone call or email response from a Service Provider to a Consumer makes for an inefficient process of finding a Service Provider. The Consumer often seeks a Service Provider to provide a small task that does not even warrant the amount of work required to find a qualified service provider to accomplish that task at a reasonable price.

In order to increase the efficiency of the process of the Consumer finding and Selecting a Service Provider, a solution is needed to automatically match Consumers and Service Providers.

2. Description of Prior Art

In prior art systems for matching Consumers and Service Providers fall short of meeting all the needs of the Consumer.

U.S. Pat. No. 7,801,756 invents a system that matches Consumers to Service Providers based on a set of questions answered by the Consumer. This patent application differs from U.S. Pat. No. 7,801,756 in that location-based information is automatically provided to both the Consumer and Service Provider, and the Service Provider must provide a confirmation that they are available to provide the service within the requested time frame.

U.S. Pat. No. 7,865,377 invents a system that matches Consumers to Service Providers based on a set of attributes, and establishes a communication channel between the Consumer and Service Provider. This patent application differs from U.S. Pat. No. 7,865,377 in that location-based information is automatically provided to both the Consumer and Service Provider, and the Service Provider must provide a confirmation that they are available to provide the service within the requested time frame.

U.S. Pat. No. 6,574,608 invents a system that matches Consumers to Service Providers based on a set of attributes, and establishes a communication channel between the Consumer to Service Provider. This patent application differs from U.S. Pat. No. 6,574,608 in that location-based information is automatically provided to both the Consumer and Service Provider, and the Service Provider must provide a confirmation that they are available to provide the service within the requested time frame.

### BRIEF SUMMARY OF THE INVENTION

An object of the invention is to overcome at least some of the drawbacks relating to the designs of prior art devices as discussed above.

The presented invention meets the above-described needs, in that it decreases the time and work required by the Consumer to find Service Provider to complete a task.

None of the previously cited U.S. patents contain a means for a Consumer to find a Service Provider using automatically provided geolocation information. This invention is an improvement over previous art in that it automatically makes a decision based on information provided by a Global Positioning System (GPS) and/or Internet Protocol (IP)-based location detector, without any extra information required by the Consumer.

The invention solves the problem of how Consumers find available Service Providers in the area that are available to provide the service, through the use of a publish/subscribe communication architecture. The invention consists of a method and system for location-based discovery of a Service Provider who enrolls in a publish/subscribe communication architecture. The invention solves the problem by requesting that the Service Providers create an online profile on a Server publically accessible on the Internet. The Service Providers create an online profile with the following list of specifications/categories: the service to be provided (e.g., taxi ride), the availability (e.g., the driver's shift, or time period that the service is available at the given price), the professional license number (e.g., the driver's medallion number), the general location or exact location, and approximate price information.

The invention employs a publish/subscribe communication architecture in which an extremely large number of Consumers may search for available Service-Providers based on a set of criteria that includes location. The result of the search requested by a Consumer is a confirmation that a Service-Provider was found and has agreed to provide the service (i.e., success), or that the system failed to find a Service-Provider to provide the service that meets the Consumer's search criteria.

The invention differs from previous art and patents in that this system contains components for automatic geolocation information gathering, a Consumer payment component, and Service-Provider notification and confirmation components.

In other aspects, the invention provides a system having features and advantages corresponding to those discussed above.

### BRIEF DESCRIPTION OF THE DRAWINGS

Having thus described the invention in general terms, reference will now be made to the accompanying drawings, which are not necessarily drawn to scale, and wherein:

FIG. 1A is a flow diagram that illustrates a method that performs Consumer to Service-Provider matching based on geolocation and search criteria.

FIG. 1B is a flow diagram that illustrates a method that finds and manages responses from available Service-Providers based on geolocation and search criteria.

FIG. 2A is a flow diagram that illustrates a method for Consumers to pay Service-Providers for services rendered.

FIG. 2B is a flow diagram that illustrates a method for the payment confirmation of payments from Consumers to Service-Providers for services rendered.

FIG. 3 is a diagram that illustrates various operations that may be performed and various component interactions of the method provided in FIG. 1A, FIG. 1B, FIG. 2A, and FIG. 2B.

FIG. 4 is a high level diagram that shows parties or entities that interact with the Service-Provider selection system.

FIG. 5 is an illustration of the environment that the presented invention may operate on.

FIG. 6 is a flow diagram of an exemplary method for performing Consumer payment and/or credit card management operations in a manner consistent with the present invention, Consumer payment to Service Provider, illustrated in FIG. 2A and FIG. 2B.

FIG. 7 is a flow diagram of an exemplary method for performing Service-Provider information entry and/or management operations in a manner consistent with the presented invention.

FIG. 8 is a diagram of an exemplary apparatus that may perform various operations in a manner consistent with the presented invention.

FIG. 9 illustrates exemplary Consumer request information that is consistent with the presented invention and noted in FIG. 3 item 320′.

FIG. 10 illustrates exemplary Service Provider information that is consistent with the presented invention and noted in FIG. 3 item 330′.

### DETAILED DESCRIPTION OF THE INVENTION

Depending upon the service requested by the Consumer, multiple Service-Providers could be returned in the form of a list to the Consumer. The Consumer is provided with a notification that a Service-Provider has been found and has agreed to perform the service, or the location of the returned Service Providers in the list 155 is displayed and superimposed on a Map on a web-enabled cell-phone, personal computer, or any web-enabled device with a human readable display.

A “Service Provider” is defined as any business or individual that provides a service to a Consumer, e.g., a taxi ride, fencing job, service of drinks at half price at a bar, or tutoring. The Consumer and Service-Provider do not necessarily have any contact prior to the request the Consumer posts on the system.

The location of the Consumer or Service-Provider can be determined by any geographic locating means available on a cell phone or personal computer or any device capable of displaying a web page on the Internet, or by the Consumer or Service-Provider updating their profile to include their location. The means to determine the Consumer or Service-Provider's location via a cell phone or any web-enabled device may include GPS, IP-addressed based locating method, cell-phone radio tower triangulation, or any other means available on a cell phone for determining location. The Consumer's location may include not only coordinates or approximate coordinates or street address or approximate street address, but also the location in the context of a business or park name. For example the location of Consumer may be displayed to the taxi driver as the User/Client/Fare is located at XYZ Bar. The process for determining a label, e.g., XYZ Bar, for the location of the Consumer involves third-party servers and services that are currently available to anyone working in the field of web-based computer programming.

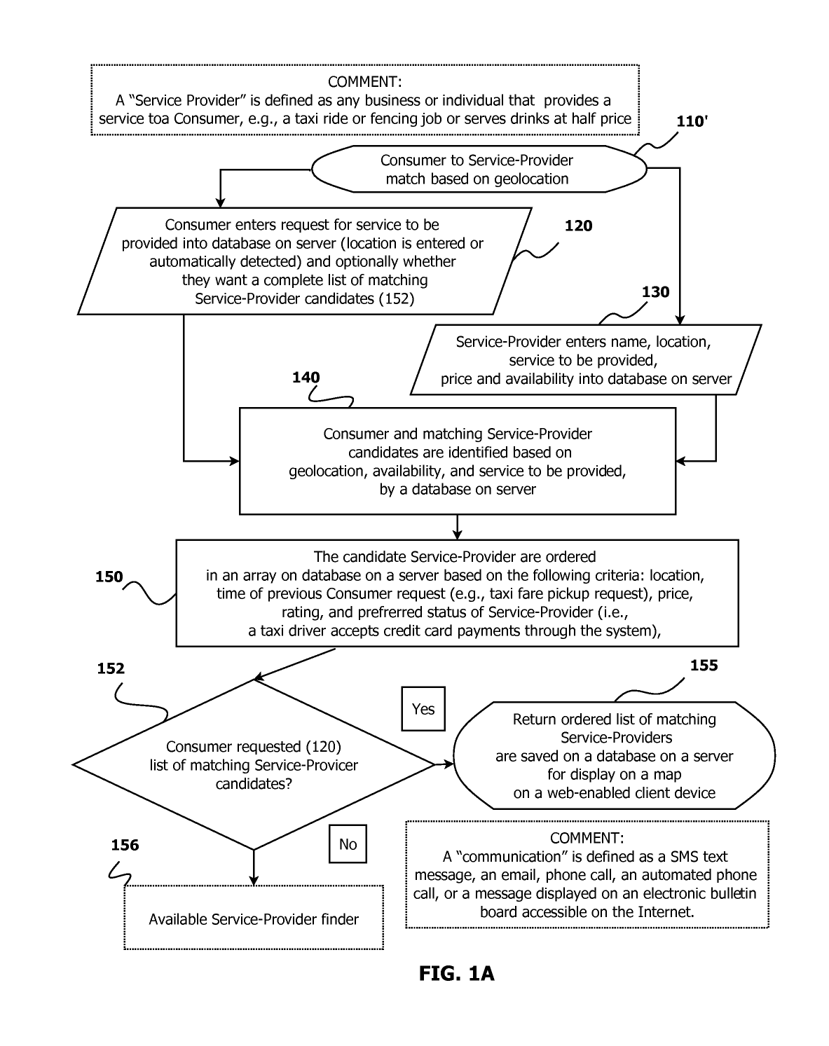

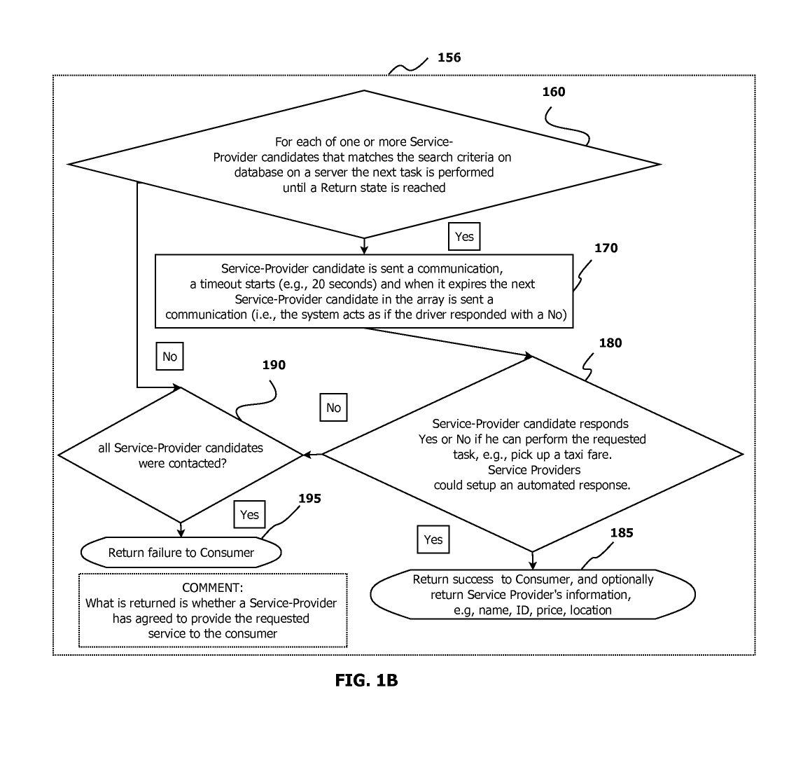

The invention differs from previous art in that previous art describes method for the location-based discovery of a Service-Provider via a human dispatcher that acts as an intermediary to provide a Consumer with a requested service, e.g., a taxi ride via an automated process. Additional previous art details a taxi dispatch service that requires human intervention. FIG. 1A and FIG. 1B details this portion of the invention. The invention detailed in this application describes a system and method for the location-based discovery of a Service-Provider which requires no human intermediary to provide a Consumer with a requested service, e.g., a taxi ride.

Additionally, the invention differs from previous art in that it employs a server that holds online profiles of Service-Providers, and at the request of the Consumer the system automatically discovers and notifies select Service Providers, and notifies the Consumer that a Service-Provider has confirmed that the company or individual Service-Provider will provide the service, without any intermediary human interaction. The Service-Providers are selected based upon their availability and geolocation as stored on a database on a server. The location could be automatically monitored by a GPS and web-enabled Cell phone, and the location reported to a Server on the Internet. The Consumer who requests the service may also have a GPS (or location aware phone via IP address or radio tower triangulation) and web-enabled Cell phone, and their location could also be reported to Server on the Internet at the time of the request. Both the Service-Provider or Consumer can simply manually enter in their geolocation via a website that reports the information to a server on the Internet, and this information can be saved in an online profile.

Within that Server a publish/subscribe communication architecture exists in which information including or related to the location of the Service Provider are published to the Consumer. The Service-Provider, e.g., taxi driver can select the option to allow for their location information to be published (to 510, 380, 330) or not be published, and an option exists to let them select a criteria for whom their location information is published to, e.g., blacklist capabilities and/or selected Consumers who meet a certain criteria.

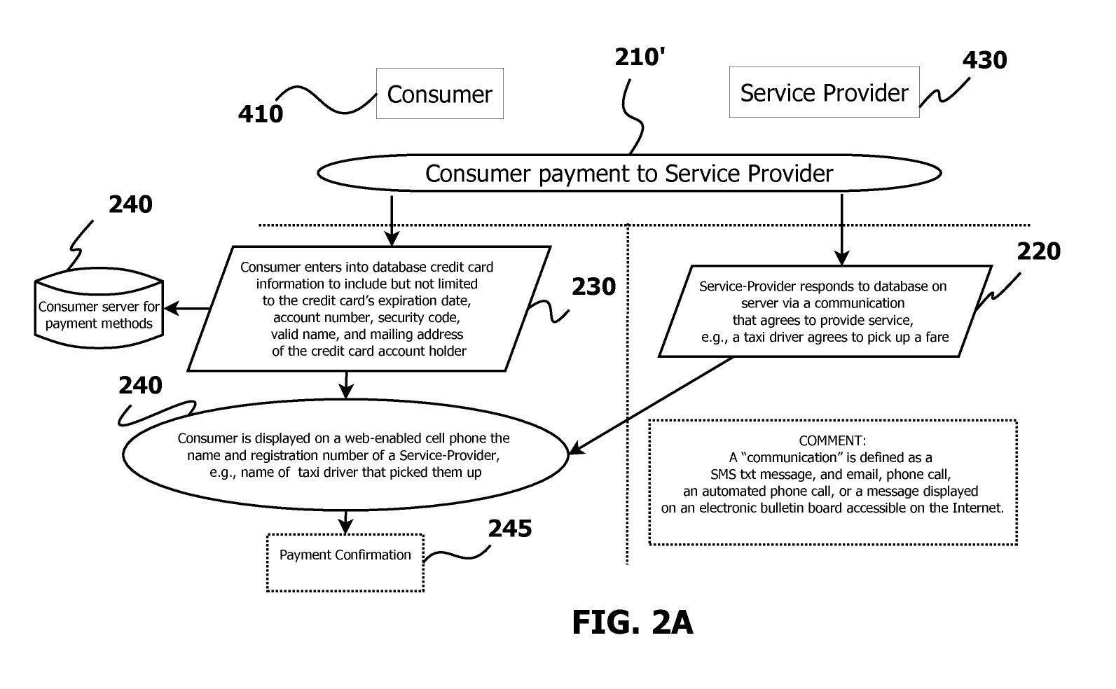

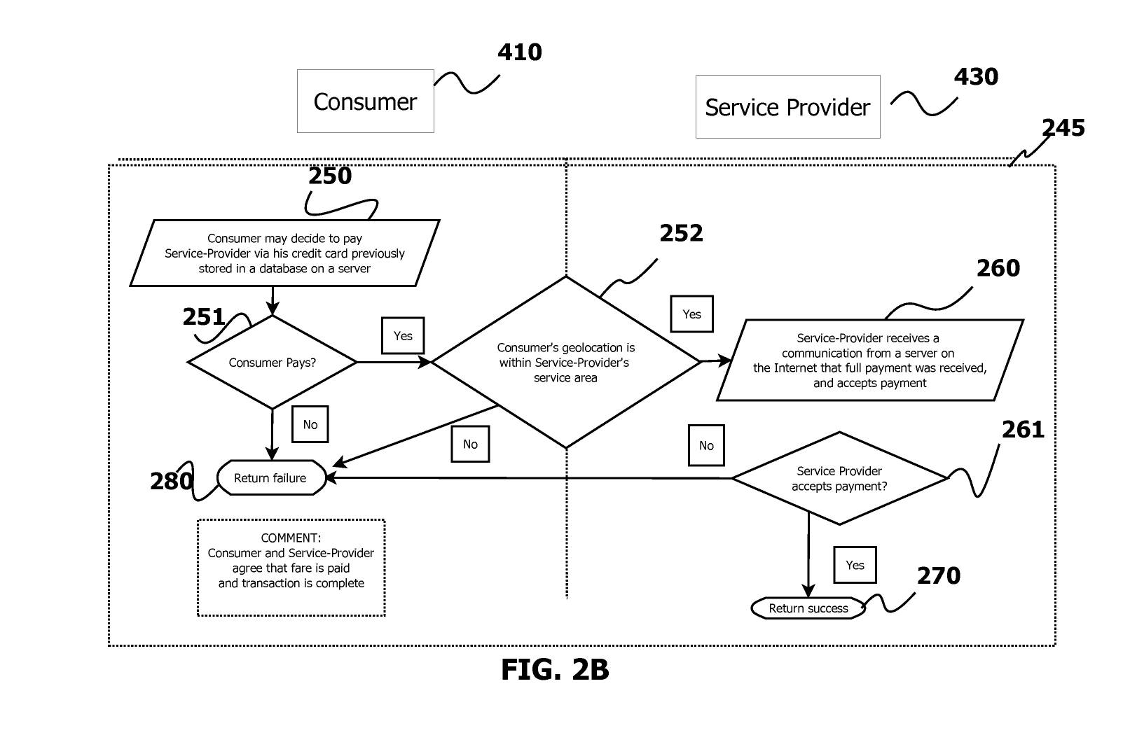

Another embodiment of the invention is a payment method for the Consumer to pay the Service Provider. FIG. 2A and FIG. 2B details this portion of the Invention, in which a Server that is accessible via the Internet contains a Profile that the Consumer and Service Provider created based on existing specifications/categories/criteria. The Consumer can store credit card information to include but not limited to the credit card's expiration date, account number, security code, valid name, and mailing address of the credit card account holder.

The uses of the invention include but are not limited to the following scenarios:

In this scenario the Consumer is a person who needs a Taxi ride, and the Service-Provider is the taxi driver. One or more taxi drivers are notified of a Consumer's request for a ride through the use of location-determining technology on a web-enabled cell phone, the taxi driver can receive notification via an active means, e.g., text message, email, phone vibrate or ring indicating a notification, an automated phone call, or a phone call from the Consumer that was routed by the system and in which real phone numbers are not accessible by either party. The first taxi driver to response to the communication with an affirmative response (yes, they will pick up the Consumer), will be allowed to provide the service to the Consumer. This scenario is detailed in FIG. 1A 110′. The Consumer may than choose to pay the Service Provider using the Consumer payment to Service Provider embodiment of the invention detailed in FIG. 2A 210′.

Also, either a Service Provider or Consumer can determine the location-based information about potential matches (Service Provider or Consumer) via passive means that include but are not limited to a list created on a webpage generated by the Server that contains a list of the Service Provider(s) or Consumer(s) that adhere to the search criteria.

The present invention may involve novel methods, apparatuses, message formats, and/or data structures for obtaining and using geolocation information in a Service-Provider selection system.

FIG. 1A and FIG. 1B illustrate a method for matching Consumers with Service-Providers based on geolocation and a set of search criteria. The Consumer enters a request for service 120 into a database which is stored on an internet accessible server 510 from a Consumer device 540. If the Consumer location is not automatically detected by 540, then the Consumer manually enters their location. The Consumer may enter an acceptable radius that the Service-Provider should be within. Service-Providers will enter their service to be provided, availability, professional license number, general location or exact location, approximate price information, and potentially other information 130 into a database which is stored on an internet accessible server 330 from a Service-Provider device 550. Service-Provider candidates are matched with Consumers 140 based on the Service-Providers position in an array 150. The specific details for the Service-Provider finder are in 156. The method accepts Consumer information 120 and Service-Provider information 130 and sends the selected Service-Provider 160 a communication (SMS text message, email, phone call, or table update to a webpage the Service-Provider is views) 170. The phone call could go through a proxy phone-exchange in which both the Consumer and the Service-Provider do not have access to the other's actual phone number. The voice phone call could be between the Consumer and the Service Provider, and would be connected automatically via the same logic that could otherwise send an SMS text message to the Service-Provider. The system waits for a response to the communication 170 from the Service-Provider within a specified amount of time (e.g., 20 seconds). If the Service-Provider responds yes to the communication 170 the matching of Consumer 120 and Service-Provider 130 will be a success and the Consumer will be notified by a communication 185. If the Service-Provider responds no or does not respond within the specified amount of time and if all Service-Provider candidates were not contacted 190 the selection of Service-Provider 160 will start again. If all Service-Provider candidates were contacted 190 the system will return failure 195 and the Consumer will be notified by a communication. Optionally, in another embodiment of the invention, if the Consumer has requested 120 152 the location of the returned Service Providers in the list 155, then the location is displayed and superimposed on a Map on a web-enabled cell-phone, personal computer, or any web-enabled device with a human readable display.

FIG. 2A and FIG. 2B are illustrations that shows a method for Consumer payment to the Service Provider 210′. Consumers enter payment information into a database 230 which is stored on a server 235. Service-Providers respond to a communication from the database 220 which displays the name and registration (and other information) of the Service-Provider to the Consumer 240. Specific details about payment confirmation are provided in 245. The Consumer may decide to pay Service-Provider 250 251 through payment methods stored on the server 235 (Credit card info, prepaid account, bar code scanner on phone, etc). If the Consumer is within the Service-Provider's area of service, as checked by 252, then the Service-Provider will receive a communication 260. Item 252 is a validation step, and the payment will not be processed unless this test is passed. The test 252 is to determine if the Consumer is within the Service-Provider's service area as determined by a geolocation determination method on a personal computer or cell phone, which may included but is not limited to GPS, IP-addressed based locating method, cell-phone radio tower triangulation, or any other means available on a personal computer or cell phone for determining location, or a manual entry of the users' location. The communication noted in 260 is from a server on the internet 260 261 confirming that a payment was received, and that the Service-Provider agrees that full payment has been received and the transaction is complete 260. The result is either a return of success 270 or failure 280.

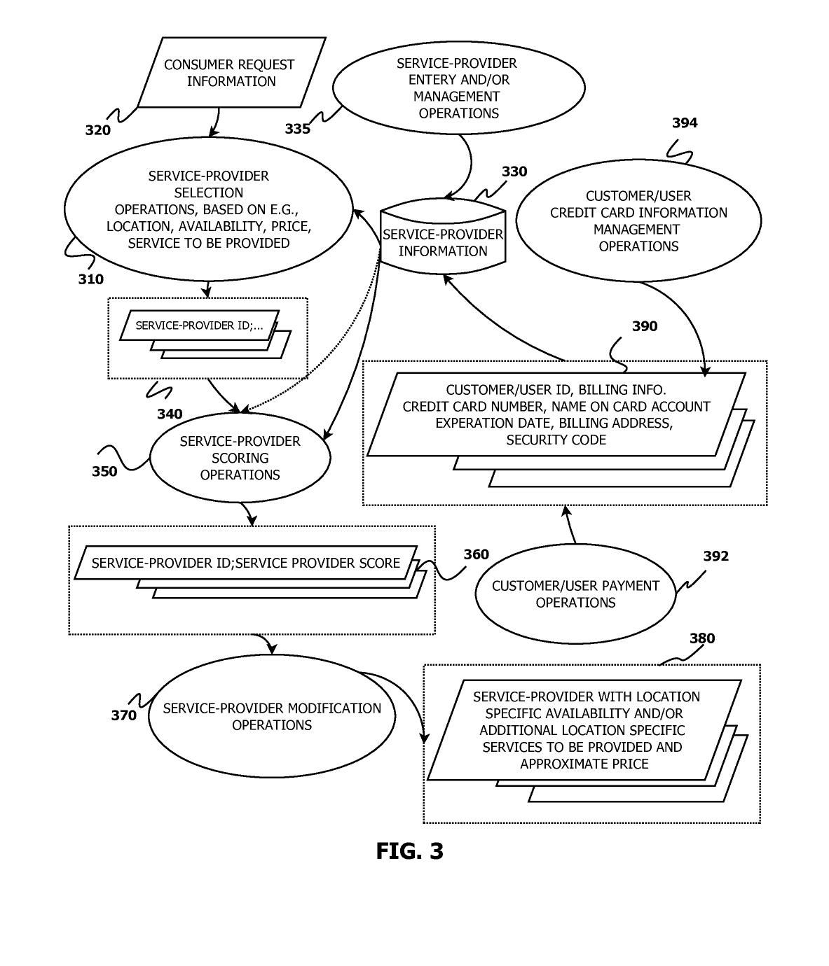

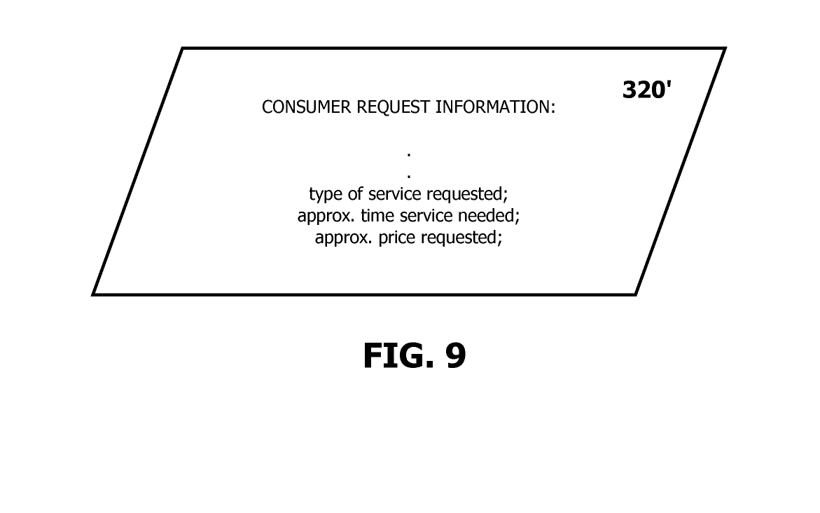

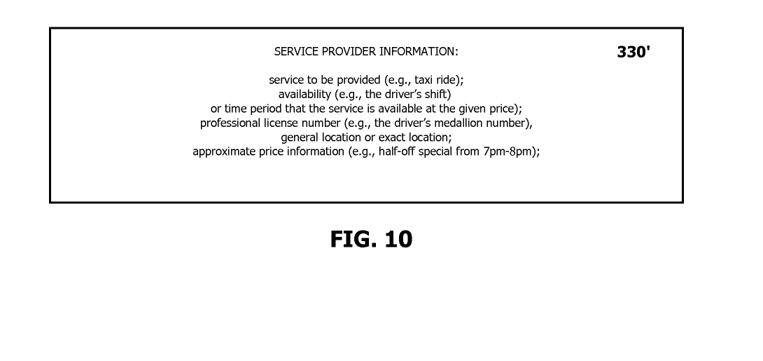

FIG. 3 is a diagram that illustrates various operations that may be performed by the presented invention, and information sets that may be used and/or generated by the presented invention. A Service-Provider selection operation 310 may be used to generate a set of services 340 using Service-Provider information 330 and request information 320. FIG. 9 and FIG. 10 provide exemplary information found in 320 and 330 respectively. The set of Service Providers 340 may include services relevant to the request information 320. For example, the request information 320 may include geolocation of a Consumer device 540 and a Service-Provider device 550. A scoring operation 350 may be used to generate a set 360 of Service-Providers. The scoring operation 350 may consider service to be provided, geolocation, performance, price, and/or rating. Service-Provider modification operations 370 may be used to generate a set 380 of Service-Providers with who are targeting a specific location and/or a specific service. A set of payment information 390 derived from Consumer payment operations 392, and Consumer credit card information management operations 394, is also illustrated.

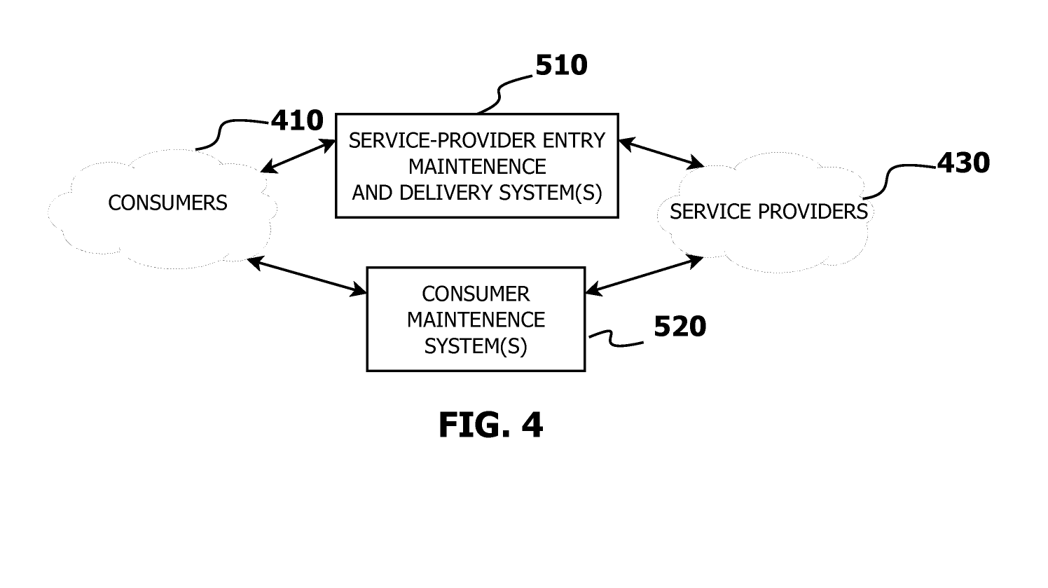

FIG. 4 is a high level diagram of a Consumer to Service-Provider matching system environment. The environment may include a Service-Provider entry system, a Service-Provider maintenance system, and delivery system (considered Service-Provider selection server) 510. Service-Providers 430 may directly, or indirectly, enter, maintain, and track Service-Provider information in the system 510. Consumers for Service-Providers 410 may submit requests for services and may accept responses to their requests. Consumers of the service provided 410 may provide usage information to the delivery system 510 (e.g., performance of the service as delivered or not delivered by the Service Provider). Other entities may provide usage information to the system 520 (e.g., whether or not the Consumer request resulted in a match with a Service Provider). The Consumer's credit card information is held on the 520.

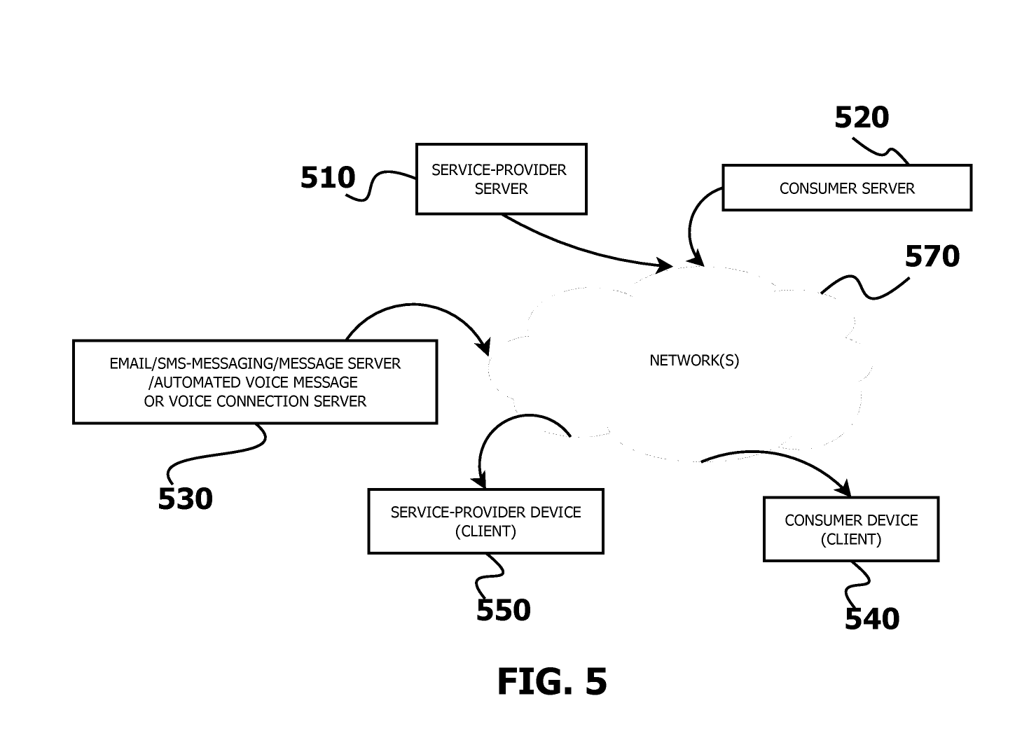

FIG. 5 illustrates an environment in which the present invention may be used. A Consumer device 540 and Service-Provider device 550 may include a mobile or desktop browser (Internet Explorer, Chrome, Firefox, etc) or a mobile phone application. A Consumer server 520 lets the Consumer device 540 access the database on the Service-Provider server 510, and thus enables a match between a Consumer and Service Provider. An email/SMS text messaging/messaging/automated voice-message/voice-connection-coordination server 530 may be used to provide e-mail/messaging/voice-connection/automated-voice-message functionality to a Consumer device 540 and/or Service-Provider device 550. A Service-Provider server 510 may be used to serve service requests to Service-Provider devices 550. A Service-Provider server 510 may also be used to serve responses regarding the service request from Service-Providers to the Consumer device 540.

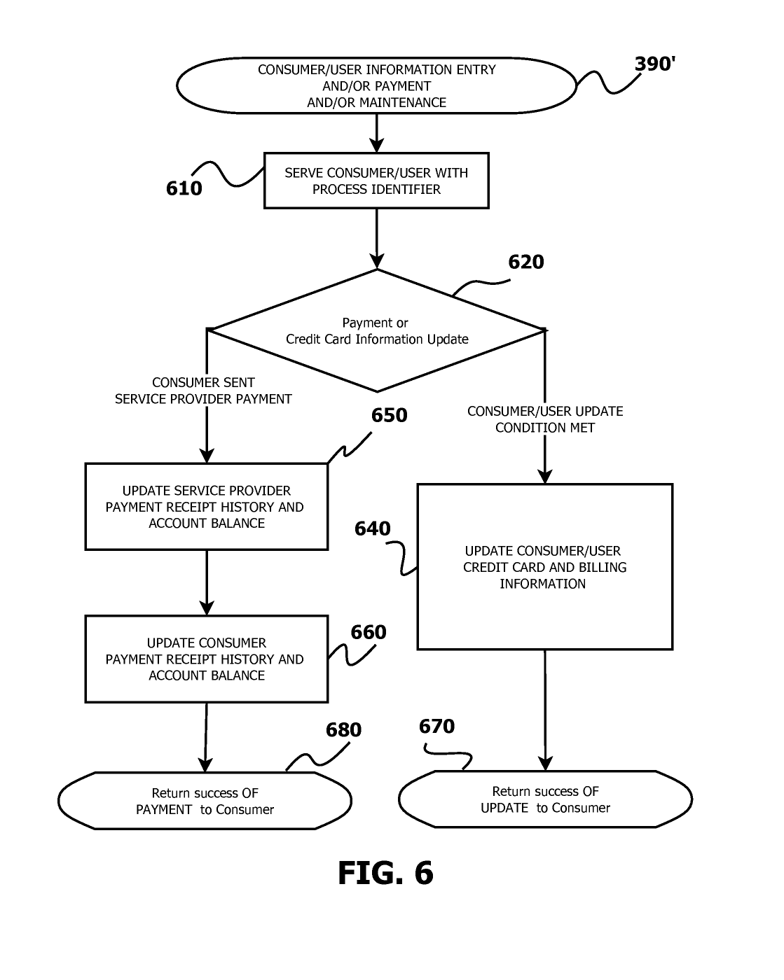

FIG. 6 is a diagram of a method of performing Consumer payment or information entry and/or maintenance operations in a manner consistent with the presented invention. Consumer information 390 may include the addition for new payment methods 210′ or updates or changes or deletion to existing payment methods 230. The method accepts a Consumer process identifier 610 and may respond by adding or updating Consumer payment information 640. For example, if the Consumer inputs credit card information, credit card information is added or updated on the database which is stored on the server 235. 650 and 660 denote an update and record of payment. A record of a payment received by a Service Provider is noted in 650, and stored in 510 and 330. The success of a payment is provided by 680, and a success of an update of credit card information is provided by 670.

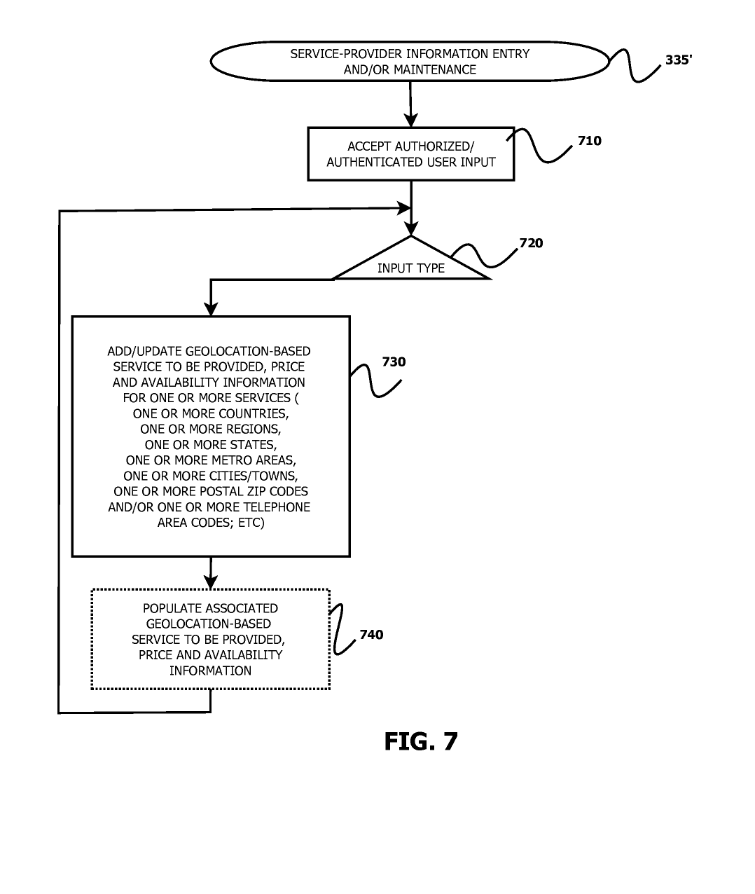

FIG. 7 is a diagram of a method for performing Service-Provider information entry and/or management operations in a manner consistent with the presented invention. The method accepts authorized and/or authenticated Service-Provider input 710. Various branches of the method may be invoked in response to various Service-Provider input 710 types. For example, if the Service-Provider inputs geolocation and availability information, service to be provided, price and availability 730, the information is added or updated on a server on a network 740. The input type 720 includes the manual update via a webpage or an automated update via a location polling process on a geolocation-enabled cell phone that updates the Service Provider's location.

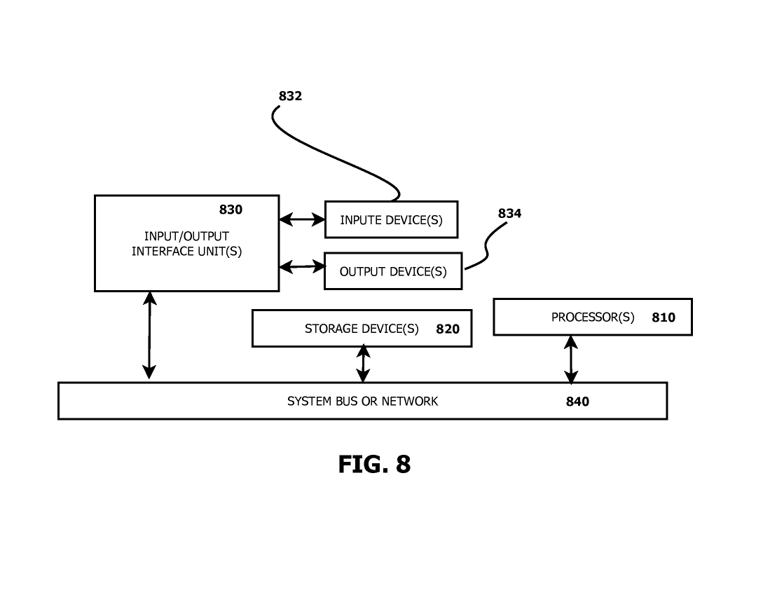

FIG. 8 is a high level diagram of a machine that may perform one or more of the operations discussed above. The invention requires the use of a machine to store data, accept inputs from the user (Consumer or Service Provider), output data to a human readable display, and connect to servers (other machines) over the Internet. The servers have the same requirements as the previously describe machine except the inputs, outputs, and displays are provided through a network connection and the input/output is performed on another machine connected to the network. The machine may be a personal computer, cell phone, or any machine capable of accessing a server and which includes one or more processors 810, storage devices 820, one or more input/output interface unites 830, and one or more system buses and/or networks 840 for facilitating the communication of information among the coupled elements. The machine must also contain one or more input devices 832 and one or more output devices 834 that may be coupled with the one or more input/output interfaces 830. The output devices 834 may include a monitor or cell phone display screen or other type of display device, which may also be connected to the system bus 840 via an appropriate interface. The processors 810, may execute any number of possible operating systems, including but not limited to Linux, Solaris, Windows-based, Adroid, iOS, webOS, and any other operating system capable of supporting a web-browser either on a cell phone, personal computer, server, or web-enabled television.

FIG. 9 provides exemplary Consumer request information found in item 320 in FIG. 3, which is consistent with the presented invention.

FIG. 10 provides exemplary Service Provider information stored in item 330 in FIG. 3, which is consistent with the presented invention.

What is claimed is:

1. A computer-implemented method for controlling the serving of Consumer to Service-Provider matching functionality using its relevancy to a request and the method comprising:
accepting, by a computer system or cell phone or mobile device, geolocation information associated with the request;
comparing, by the computer system, the accepted geolocation information associated to a searching Consumer, with geolocation information associated to potential matching Service Providers;
determining, by the computer system, the relevancy of the Service-Providers that are returned as a result of the Consumer's search using at least the comparison result;
controlling, by the computer system, the serving of the Consumer's geolocation-based search and other option criteria, for delivery/rendering on a client device, using the determined relevancy of search results;
determining, by the computer system, whether the Service-Providers returned by the search are within the acceptable radius the Consumer's geolocation-based search;
notifying, by the computer system, via a communication to a web-enabled mobile or desktop device that a Service Provider that meets the Consumers's search criteria are available and within the acceptable geolocation radius as determined by a search or preset setting; and
notifying, by the computer system, via a communication to a web-enabled mobile or desktop device that a Consumer are searching for a Service Provider that meets the Service Provider's profile within the acceptable geolocation radius as determined by a search or preset setting.

2. The method of claim 1 wherein the area includes a circular area of radius around a specified geographic reference point, which may or may not be automatically determined by a user's, either a Consumer or Service-Provider, cell phone's previously listed location determining methods.

3. The method of claim 1 wherein the geolocation data employed to locate Consumers and Service-Providers include at least one of Global Positioning System (GPS) coordinates, a WiFi connection location, cell-phone radio tower triangulation, a Bluetooth connection location, an IP address, a Media Access Control address (MAC) address, Radio Frequency Identification (RFID) data, street address data, latitude and longitude data, a zip code, a city, a region, or a manual entry of the Consumer or Service-Provider's location.

4. The method of claim 1 wherein the notification communication includes but is not limited to a Short Message Service (SMS) text message, an email, phone call, an automated phone call, or a message displayed on an electronic bulletin board accessible on the Internet.

5. Apparatus for controlling serving of Consumer to Service-Provider matching process using its relevancy to a request, the apparatus comprising at least one processor; and at least one storage device storing processor-executable instructions which, when executed by at least one processor, perform a method of:
accepting geolocation information associated with the request;
comparing the accepted geolocation information associated with the request with geolocation targeting information associated with the Consumer's search request to generate comparison results;
determining the relevancy of the returned Service-Providers that results from the Consumer's search using at least the comparison results;
controlling the serving of the results of the Consumer's search, for rendering on a client device, using the determined relevancy of the Service-Provider returned by the search;
determining whether a potential search result Service-Provider has the acceptable geolocation and other optional search criteria including but not limited to the service to be provided, availability, professional license number, general location or exact location, approximate price information;
determining a score for the Consumer to Service-Provider matching functionality using at least the geolocation of the Service-Provider, and optionally the service to be provided, availability, professional license number, general location or exact location, approximate price information of the Service-Provider;
determining whether the Service-Provider responses in the affirmative as to whether or not they can complete the requested task;
notifying the Consumer whether the Service-Provider responses in the affirmative as to whether or not they can complete the requested task;
notifying each Service-Provider in a list sequentially and waiting a set time for an affirmative response until either all Service-Provider in a list are notified or one responds in the affirmative;
notifying via a communication to a web-enabled mobile or desktop device that a Service Provider that meets the Consumers's search criteria are available and within the acceptable geolocation radius as determined by a search or preset setting;
notifying via a communication to a web-enabled mobile or desktop device that a Consumer are searching for a Service Provider that meets the Service Provider's profile within the acceptable geolocation radius as determined by a search or preset setting; and
wherein the act of controlling the serving of the Service-Providers returned by the search further uses the score of the Service-Provider, and wherein the geolocation associated with the search, in regards to both the Consumer's and Service-Provider's location, corresponds to an area defined by a radius around at least one geographic reference point, which may be automatically determined on a desktop or mobile device via one of the previous means noted, or manually entered.

6. The apparatus of claim 5 wherein the Consumer searching for a Service-Provider may or may not have had previous contact.

7. The apparatus of claim 5 wherein the Consumer is provided a list of Service-Providers 155 that is displayed and superimposed on a map, corresponding to the Service-Provider's location, on a web-enabled cell-phone, personal computer, or any web-enabled device with a human readable display.

8. The apparatus of claim 5 wherein the geolocation data employed includes at least one of Global Positioning System (GPS) coordinates, a WiFi connection location, cell-phone radio tower triangulation, a Bluetooth connection location, an IP address, a Media Access Control address (MAC) address, Radio Frequency Identification (RFID) data, street address data, latitude and longitude data, a zip code, a city, a region, or a manual location entry,

9. The apparatus of claim 5 wherein the notification communication includes but is not limited to a Short Message Service (SMS) text message, an email, phone call, an automated phone call, or a message displayed on an electronic bulletin board accessible on the Internet.
